(19) United States
(12) Patent Application Publication
(10) Pub. No.: US 2019/0271234 A1
(43) Pub. Date: Sep. 5, 2019

(54) CERAMIC-MATRIX-COMPOSITE (CMC) TURBINE ENGINE BLADE WITH PIN ATTACHMENT, AND METHOD FOR MANUFACTURE

(71) Applicant: Siemens Aktiengesellschaft, München (DE)

(72) Inventors: Christian Xavier Campbell, West Hartford, CT (US); Evan C. Landrum, Charlotte, NC (US); Zachary D. Dyer, Chuluota, FL (US)

(21) Appl. No.: 16/343,438

(22) PCT Filed: Oct. 24, 2016
(86) PCT No.: PCT/US2016/058369

§ 371 Date: Apr. 19, 2019

(51) Int. Cl. F01D 5/28; F01D 5/32

(52) U.S. Cl. CPC F01D 5/284; F01D 5/282; F05D 2300/614; F05D 2300/6033; F05D 2300/6034; F01D 5/323

(57) ABSTRACT

Clevis-type pin attachment mounts for ceramic-matric-composite (CMC) blades (50) accommodate varying thermal expansion rates between ceramic blades and the mating engine rotor disc (46). A two-dimensional array of apertures (124, 126, 128, and 130) the CMC blade shank (70) receives of rows of load-carrying pins (132, 134, 136, and 138). Tensile loads applied to the pin and aperture array are distributed within the blade shank, so that applied tensile load stress is split between successive rows of apertures and pins, so that each row of apertures carries its own tensile load plus aggregate tensile load of all other rows of apertures that are closer to the blade tip. Axial gaps (GA) between tips of load-carrying pins and partial-depth apertures in clevis attachment pieces (100, 102) provide compressive loading on the blade shank (70).

### PRIORITY CLAIM

This application incorporates by reference in its entirety International Application entitled “CERAMIC-MATRIX-COMPOSITE (CMC) TURBINE ENGINE BLADE WITH PIN ATTACHMENT, AND METHOD FOR MANUFACTURE”, filed concurrently herewith, and assigned application number (unknown).

### TECHNICAL FIELD

The invention relates to components for combustion turbine engines. More particularly, the invention relates to pin attachment mounts for ceramic-matrix-composite (CMC) blades, which during engine operation, accommodate varying thermal expansion rates between ceramic blades and metallic components that mate the blade to a corresponding rotor disc of the engine, and methods for making such components.

### BACKGROUND

Ceramic matrix composite (“CMC”) structures are being incorporated into gas turbine engine components as insulation layers and/or structural elements of such components, such as insulating sleeves, ring segments, vanes, and turbine blades. These CMCs provide better oxidation resistance, and higher temperature capability, in the range of approximately 1150 degrees Celsius (“C”) for oxide/oxide (“Ox/Ox”) based ceramic matrix composites, and up to around 1350 degrees C. for Silicon Carbide fiber-Silicon Carbide core (“SiC—SiC”) based ceramic matrix composites, whereas nickel or cobalt based superalloys are generally limited to approximately 950 to 1000 degrees Celsius under similar operating conditions within engines. While 1150 degrees C. (1350 degrees C. for SiC—SiC based CMCs) operating capability is an improvement over traditional superalloy temperature limits, mechanical strength (e.g., load bearing capacity) of CMCs is also limited by grain growth and reaction processes with the matrix and/or the environment at 1150/1350 degrees C. and higher. Therefore, some combustion-turbine engine components, such as blades and ring segments, utilized hybrid combinations of CMC and superalloy or other metals structures, which include the benefits higher temperature resistance of the CMC material and mechanical strength of the metals. However, inclusion of mating CMC and superalloy substrates in combustion turbine engines presents new and different thermal expansion mismatch challenges. During gas turbine engine operation, superalloy and CMC materials have different thermal expansion properties. Superalloy material expands more than the CMC material, which in extreme cases leads to crack formation and/or delamination in the CMC material. In some cases expansion rates between the CMC material and the superalloy or other metallic material are affected by the local ambient temperatures of the respective components.

By way of background, CMC structures typically comprise a solidified ceramic substrate, in which are embedded ceramic fibers. The embedded ceramic fibers within the ceramic substrate of the CMC improve elongation rupture resistance, fracture toughness, thermal shock resistance, and dynamic load capabilities, compared to ceramic structures that do not incorporate the embedded fibers. The CMC embedded fiber orientation also facilitates selective anisotropic alteration of the component's structural properties. CMC structures are fabricated by laying-up or otherwise orienting ceramic fibers, also known as “rovings”, into fabrics, filament windings, tows, or braids. Fiber-reinforced ceramic substrate fabrication for CMCs is comparable to what is done to form fiber-reinforced polymer structural components for aircraft wings or boat hulls. Unless the ceramic fibers are pre-impregnated with a resin containing ceramic material, they are subsequently impregnated with ceramic material by such techniques as gas deposition, melt infiltration, preceramic polymer pyrolysis, chemical reactions, sintering, or electrophoretic deposition of ceramic powders, creating a solid ceramic structure with embedded, oriented ceramic fibers.

Ox/Ox CMCs are being evaluated to replace nickel superalloys as rotating components in combustion or gas turbine engines. An important strength criterion for a rotting blade is the specific strength (strength over density) of the material. Nickel-based superalloys have high strength and high density (i.e., approximately 336 MPa and 8.1 g/cm³), while Ox/Ox CMS have lower strength and density (i.e., approximately 81 MPa and 2.7 g/cm³). Based on these physical property measurements, specific strength of superalloys is about 38% higher than that of Ox/Ox CMCs. Given the lower specific strength of CMC materials, design challenges for construction of CMC blade bodies include meeting rotating centrifugal force (“CF”) loads imparted on material forming the walls of the airfoil portions of such blade bodies, and attachment of the CMC blade bodies to turbine rotor discs in a way that can carry the centrifugal load of the entire composite blade. Another CMC blade attachment challenge is compatibility of blade mounting with fir-tree shaped attachment systems that have been utilized historically for mounting metallic blades to rotor discs of combustion turbine engines.

Typically, known metallic turbine blade bodies meet CF load requirements by use of tapered wall construction along the radial length or stand of the airfoil. Airfoil walls are thicker at the blade platform portion than at the blade tip. Such blade wall taper also facilitates easier casting of metallic blades. Fir-tree blade root to rotor disc attachment structures efficiently spread tensile CF forces imparted on the blade across faces of the mating blade root and rotor disc recess teeth, while necked portions within the blade root metal substrates have sufficient strength to absorb and distribute both tensile and compressive forces imparted therein. In contrast, CMC materials do not have strength properties needed to fabricate a fir-tree compatible blade root. A toothed and necked blade root formed of CMC material cannot meet the tensile load requirements in its neck portion, compared to a comparable superalloy material having approximately 38% higher specific strength. Moreover, total compressive loads imparted in the necked portion the CMC material, if left unchecked, are sufficiently high enough to cause delamination of the embedded ceramic fibers in that region. Traditional fir-tree blade mounting systems also beneficially offer flexibility to accommodate thermal growth mismatch between blades and their disc rotor. The attachment system decouples thermal growth of the disc and the blade root by allowing relative sliding along the fir-tree mating teeth. Given the greater thermal mismatch between CMC blade bodies and their rotor disc, it is desirable to decouple them through use of an attachment system that is as effective as a fir-tree type blade mounting system.

U.S. Pat. No. 8,231,354, issued Jul. 31, 2012, entitled “TURBINE ENGINE AIRFOIL AND PLATFORM ASSEMBLY”, is incorporated by reference in its entirety herein, and describes a composite-construction turbine blade with a metallic airfoil having a shank portion that is attached to two flanking platform portions, which are constructed of a different alloy, by clevis pins formed in the platform portions. The platform portions include integrally formed fir-tree blade root profiles, for attachment to mating recesses formed within a rotor disc of a combustion turbine engine.

As previously discussed, ring segments of combustion turbine engines also are susceptible to thermal expansion mismatch with adjoining metallic support structures, such as turbine vane casings and their support rings. Both U.S. Pat. No. 7,278,820, issued Oct. 9, 2007, entitled RING SEAL SYSTEM WITH REDUCED COOLING REQUIREMENTS”, and U.S. Pat. No. 7,950,234, issued May 31, 2011, entitled “CERAMIC MATRIX COMPOSITE TURBINE ENGINE COMPONENTS WITH UNITARY STIFFENING FRAME” (which are both incorporated by reference in their respective entireties herein) incorporate cantilevered pins, supported by the turbine casing support structure, whose free ends slidably engage apertures formed in the ring segment supporting structure. The sliding engagement facilitates relative sliding motion between the engine casing support structure and the ring segment as the ring segment material expands and contracts at different rates than its mating metallic support structure. Factors other than material composition differences that affect relative thermal expansion of components include component locations with the turbine engine. For example, some portions of a ring segment or its support structure have more cooling air exposure than portions that are directly exposed to combustion gasses.

### SUMMARY OF INVENTION

In exemplary embodiments described herein, components for combustion turbine engines, such as ring segments, CMC blades and CMC vanes, are coupled to turbine engines by mounting systems, which comprise clevis pin-type attachments. The component is slidably coupled to one or more pins. Both ends of the respective pins project from respective sides of a through-aperture formed in the component. Both pin ends are also coupled opposed support structure within the engine, forming the clevis-like structure. The pinned component slides along the pin, as needed to accommodate thermal expansion, within limits of a gap established between the supported ends of the pin. In some embodiments, the defined gap is established by utilizing a pin, which bottoms out in surrounding support structure, so that the minimum gap is defined by length of the pin. In some blade embodiments, the pin is shorter than depth of pin-retaining apertures in the pin support structure. In such a short-pin construction, the gap formed between the ends of the pin and their respective aperture maximum depths limits compression of the portion of the component incorporating the through-aperture, once the pin ends bottom out in the receiving apertures. Such a short pin construction is useful for applying a maximally permitted compression on a CMC-material mounting shank of a turbine blade, which is captured between opposing portions of the support structure, such as a pair of opposed clevis attachment pieces. In some ring segment embodiments, the sliding pin structure accommodates thermal expansion in the axial direction of the turbine engine, which is generally aligned along axial length of the engine's rotor shaft. In some ring segment embodiments, the sliding pin structure is additionally incorporated as part of another sliding joint structure, such as a dovetail mount, that in turn accommodates thermal expansion in the circumferential direction of the engine casing, such as between adjoining ring segments forming the ring structure, or any other desired orientation, within the engine.

In some embodiments, the component is a turbine blade or vane constructed from CMC material, having a shank portion that is also formed from CMC material. In some embodiments, CMC material forming the shank portion of the blade or vane body defines a two-dimensional array of pin-receiving apertures, in order to spread tensile loads relatively equally throughout the shank. In some embodiments, the CMC blade or vane has a pair of shank portions, to split tensile loads. In some embodiments, a CMC blade is constructed of multiple plies of ceramic fabric having different axial lengths from the blade shank to the blade tip, such that the wall thickness tapers, from thicker at the shank portion to thinner at the blade tip.

In some embodiments, the mounting system is a ring segment mounting system. In such systems, the ring segment includes a first flange portion that is constrained between second and third flanges of supporting components of the turbine engine casing, in clam shell-like fashion. A first aperture, through-aperture in the first flange of the ring segment is axially aligned with respective second and third apertures formed in the second and third flanges. A mounting pin is slidably engaged within the first through-aperture. Ends of the mounting pin are retained within the second and third apertures, forming a clevis pin-type mounting structure, which accommodates thermal mismatch expansion between the ring segment and the corresponding support structures of the turbine engine casing. In some embodiments, the second flange is incorporated within a forward isolation ring that supports the ring segment. In some embodiments, the third flange is incorporated within vane blocks that support the ring segment. The ring segment mounting pins in some embodiments are retained within support structures that permit sliding motion in a second (e.g., circumferential) direction, which is complimentary to the sliding direction of the clevis pin-type mounting pin structure (e.g., an axial sliding direction).

Exemplary embodiments of the invention feature a ceramic-matrix-composite (CMC) blade for a combustion turbine engine, including a fiber-reinforced, ceramic blade body. The blade body includes an airfoil portion with a tapered blade wall defined between an outer wall surface and an inner wall surface. The outer wall surface defines respective concave pressure and convex suction sides joined by leading and trailing edges; a first end defining at least one blade shank. The at least one blade shank has a shank first portion proximate the airfoil portion, a shank tip distal the airfoil portion, and first and second shank sides between the first and tip distal portions thereof. The blade body has a second end coupled to a blade tip; with blade wall thickness in the airfoil portion between the outer and inner wall surfaces decreasing from the first end to the second end of the blade body. The blade body includes a layered structure of laid-up ceramic fibers embedded within cured ceramic material, including at least one inner layer, which delimits the inner wall surface. The inner layer has a length extending from the at least one blade shank distal tip of the first end of the blade body to the second end of the blade body, and successively shorter length extending layers, applied over previously laid-up layers. Each successively shorter layer has a length extending from the at least one blade shank distal tip of the first end toward the second end thereof, so that thickness of the composite, laid-up, successive fiber layers decreases from the first end to the second end. A two-dimensional array of rows of apertures is formed in the at least one blade shank. Each of the apertures extends through the at least one blade shank between the first and second shank sides, for insertion and receipt of corresponding load-carrying pins. Rows of apertures formed proximate the distal tip have larger diameter than rows of apertures formed closer to the blade tip, so that when any axial tensile load is applied to the at least one blade shank while corresponding load-carrying pins are inserted into their respective apertures, the applied tensile load stress is split between successive rows of apertures from proximate the at least one blade shank distal tip toward the blade tip, so that each row of apertures carries its own tensile load plus aggregate tensile load of all other rows of apertures in the blade shank portion that are closer to the blade tip.

The respective features of the exemplary embodiments that are described herein may be applied jointly or severally in any combination or sub-combination.

### BRIEF DESCRIPTION OF DRAWINGS

The exemplary embodiments are further described in the following detailed description, in conjunction with the accompanying drawings, in which:

FIG. 1 is a partial axial, cross sectional view of a gas or combustion turbine engine, incorporating one or more clevis-type, pin-mounted components constructed in accordance with exemplary embodiments further described herein;

FIG. 2 is a perspective view of a CMC turbine blade, which incorporates a pin mounting system embodiment further described herein;

FIG. 3 is an elevational cross section of the turbine blade of FIG. 2, taken along 3-3 thereof, showing respective layed-up ceramic fabric layers forming a tapered blade wall;

FIG. 4 is an elevational cross section of the turbine blade of FIG. 2, taken along 4-4 thereof, showing a column of mounting pins within a two-dimensional, matrix array of mounting pins, with the pins passing through the blade shank through-apertures, and with ends of the pins inserted in mating partial-depth apertures formed within clevis attachment pieces, the clevis attachment pieces retained within a fir-tree recess of a rotor disc of a combustion turbine engine;

FIG. 5 is a plan cross section of the turbine blade of FIG. 2, taken along 5-5 thereof, showing a row of mounting pins within the aforementioned two-dimensional, matrix array of mounting pins;

FIG. 6 is a schematic elevational view of the aforementioned two-dimensional, matrix array of blade shank through apertures, prior to insertion of pins;

FIG. 7 is an enlarged view of an alternative embodiment of an elongated through-aperture formed within a component, which facilitates sliding motion of the pin along the long axis of the aperture, such as for accommodation of thermal expansion in the circumferential direction within the engine, while sliding motion normal to the figure accommodates thermal expansion in the axial direction within the engine;

FIG. 8 is a perspective view of an alternate embodiment of a CMC turbine blade, which incorporates a twin shank and clevis pin attachment pieces, mounting-system embodiment further described herein;

FIG. 9 is a plan cross section of the turbine blade of FIG. 8, taken along 9-9 thereof, showing the twin shanks and clevis attachment pieces , with the blade shanks retained within a fir-tree recess of an engine rotor disc by a dog-bone-shaped support;

FIG. 10 is a partial axial, elevational cross section of a ring segment and support structure within the turbine section of a combustion turbine engine, which incorporates a pin mounting system embodiment further described herein;

FIG. 11 is a fragmentary perspective view of the ring segment and supporting structure of the ring segment of FIG. 10;

FIG. 12 is a detailed schematic, elevational view of the ring segment of FIG. 10, showing pin retainer pieces, which retain respective projecting ends of the mounting pins that pass through a flange of the ring segment, accommodating both axial and circumferential relative sliding of the ring segment during thermal expansion;

FIG. 13 is an elevational cross section of a pin retainer piece and mounting pins, taken along 13-13 of FIG. 12;

FIG. 14 is an exploded assembly view of the ring segment of FIG. 10;

FIGS. 15 and 16 show alternative embodiments of mounting pins for retaining a ring segment;

FIG. 17 is an elevational view of an alternative embodiment of a slidable ring segment mounting system, which incorporates a mounting pin retained within a solid clevis and dovetail mounting joint;

FIG.18 is an elevational view of an alternative embodiment of a slidable ring segment mounting system, which incorporates a mounting pin retained within a pair of separate clevis pieces, which are separately dovetail mounted to the engine casing;

FIGS. 19 and 20 are respective elevational views of an alternative embodiment of a slidable ring segment mounting system, which incorporates mounting pin ends retained within elongated apertures, for accommodation of circumferential thermal expansion; and

FIGS. 21 and 22 are respective elevational views of an alternative embodiment of a slidable ring segment mounting system, which incorporates mounting pin ends retained within circumferential grooves, for accommodation of circumferential thermal expansion.

To facilitate understanding, identical reference numerals have been used, where possible, to designate identical elements that are common to the figures. The figures are not drawn to scale.

### DESCRIPTION OF EMBODIMENTS

Exemplary embodiments described herein are utilized to couple or otherwise affix components, including by way of example CMC blades, CMC vanes, and ring segments within combustion turbine engines. Those components are coupled to the turbine engine's casing or its rotor discs by clevis-type attachment pins. The pins are slidably engaged within corresponding through-apertures that are formed within the component, with respective ends of the pins projecting outwardly from the component. Both projecting pin ends engage structural supports within the engine, such as a turbine vane carrier-supporting ring or a rotor disc. The slidably mounted component is movable along the corresponding attachment pin, within a gap formed between the engaged ends of the pins and outer facing surfaces of the component through-aperture. The component freedom to move along the pin gap distance advantageously accommodates thermal expansion mismatch between the component and its supporting structure. By way of example, blades are pin-mounted to rotor discs, whereas vanes or ring segments are pin-mounted to turbine vane carriers or other engine casing supporting rings. In some embodiments, pin-mounted CMC blades and vanes are structurally self-supporting, relying on internally embedded fibers to provide additional strength to its fiber-reinforced, ceramic substrate.

Some embodiments of the CMC blade and vane components have a solidified, fiber-reinforced ceramic substrate, with ceramic fibers embedded therein. In accordance with method embodiments of the invention, exemplary CMC turbine blades are made by laying-up ceramic fibers into a layered, tapered structure. In some CMC blade manufacture embodiments, innermost fabric layers extend in length from a distal end of a blade shank to the blade tip. Subsequently applied, outboard fabric layers extend from the blade shank distal end toward the blade tip in progressively shorter lengths. In this way, the blade wall structure is thicker proximate the blade shank, where it is attached to a corresponding rotor disc, and tapers to a thinner wall structure proximate the blade tip. Some CMC blade embodiments incorporate a two-dimensional array of attachment pins within the blade shank, in order to distribute centrifugal loads imparted on the blade uniformly (e.g., within plus or minus five percent) throughout the blade shank. When constructing CMC blades in accordance with the methods described herein, if the ceramic fibers forming the blade body are not already pre-impregnated with ceramic material prior to their laying-up, they are subsequently infiltrated with ceramic material, forming a solidified, fiber-reinforced ceramic substrate. In some embodiments, the two-dimensional array of attachment pins within an attachment shank is incorporated into CMC vanes for turbine engines. Typically a CMC turbine vane will have shanks at both ends of the vane body, i.e., outboard of the vane airfoil.

Some embodiments of ring segments, and their mounting system, utilize a clevis pin-type mounting system on at least one axial end of the ring segment, e.g., the forward axial end that is closest to the engine combustion section. A forward axial end of the ring segment includes a first flange or a lug that projects outwardly in a generally radial direction, away from the engine's combustion path, and incorporates one or more first through-apertures. The first lug is flanked by opposed second and third flanges, in clam shell-like fashion, which project inwardly toward the combustion path. In some embodiments, the second and third flanges are incorporated within isolation rings and vane blocks, which are in turn coupled to the engine casing of the combustion turbine engine. The second and third flanges incorporate respective second and third apertures, which are coaxial with the first through-aperture of the first flange. A mounting pin is captured within the first through-aperture, with its ends in turn captured and supported within the second and third apertures of the respective second and third flanges. The first flange is slidable along the mounting pin, within the gap formed between the second and third flanges, which accommodates thermal expansion. In some ring segment embodiments, the second and third flanges incorporate sliding joints around their second and third apertures, such as pin retaining pieces, dovetail joints, or circumferential grooves, which facilitate thermal expansion in another direction within the engine (e.g., a circumferential direction about the engine casing).

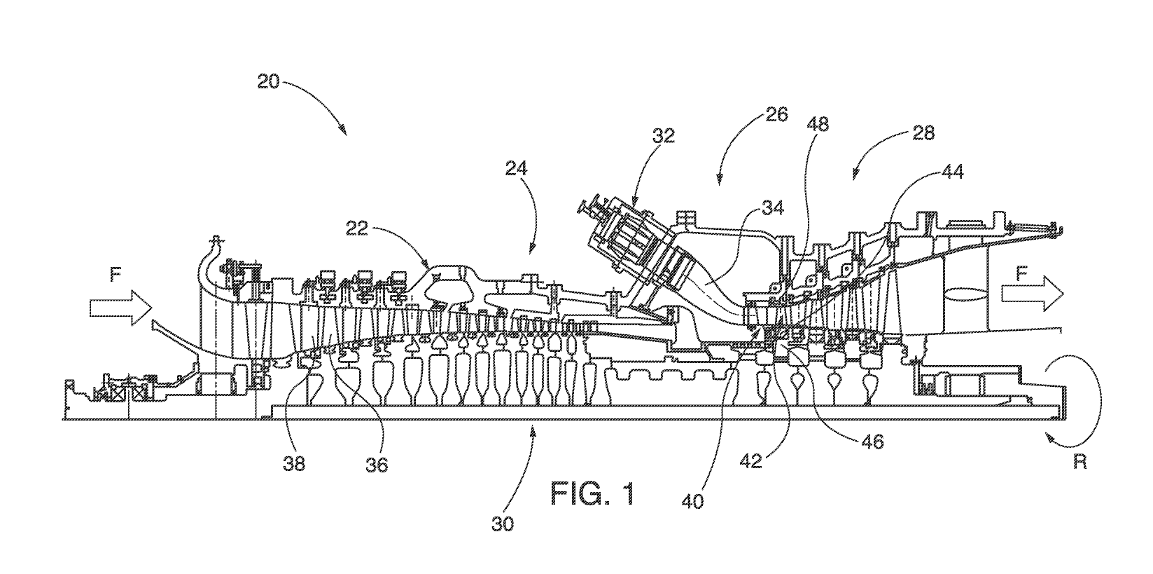

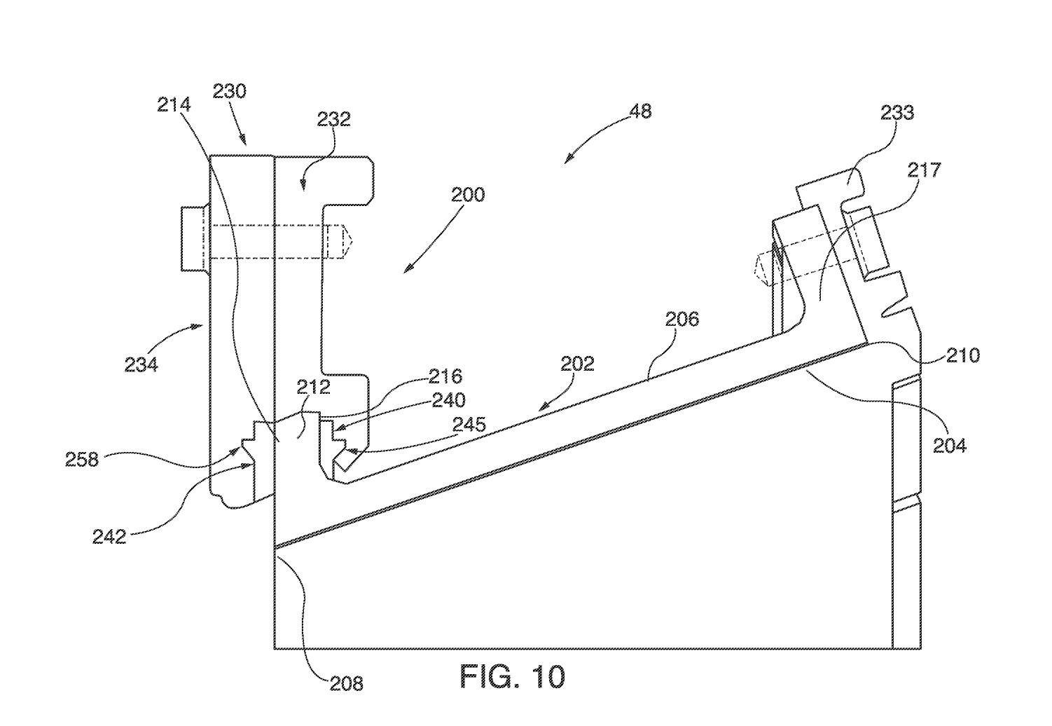

FIG. 1 shows a gas turbine engine 20, having an engine casing 22, a multi-stage compressor section 24, a combustion section 26, a multi-stage turbine section 28 and a rotor 30. One of a plurality of basket-type combustors 32 is coupled to a downstream transition 34 that directs combustion gasses from the combustor to the turbine section 28. Atmospheric pressure intake air is drawn into the compressor section 24 generally in the direction of the flow arrows F along the axial length of the turbine engine 20. The intake air is progressively pressurized in the compressor section 24 by rows of rotating compressor blades 36 and directed by mating compressor vanes 38 to the combustion section 26, where it is mixed with fuel and ignited. The ignited fuel/air mixture, now under greater pressure and velocity than the original intake air, is directed through a transition 34 to the sequential rows of vanes 40 and blades 42 in the turbine section 28. The engine's rotor 30 and shaft retains the plurality of rows of airfoil cross sectional shaped turbine blades 42 by a blade root 44 attached to a rotor disc 46. Tips of the turbine blades 42 are circumscribed by a casing ring 48. The casing ring 48 comprises a series sector-shaped ring segments. An exemplary ring segment 202 embodiment is shown in FIGS. 10 and 11. Embodiments of the CMC blade 42 and vane 40 components described herein are designed to operate in engine temperature environments of up to 1950 degrees Celsius. In some embodiments, those CMC components are structurally self-supporting, without the need for metallic members or other supporting metallic substrates.

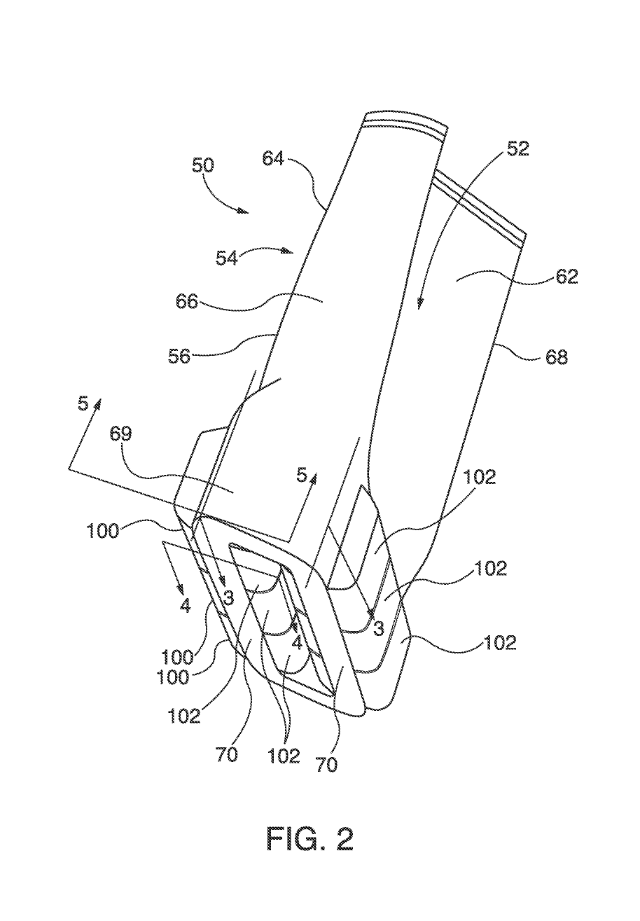

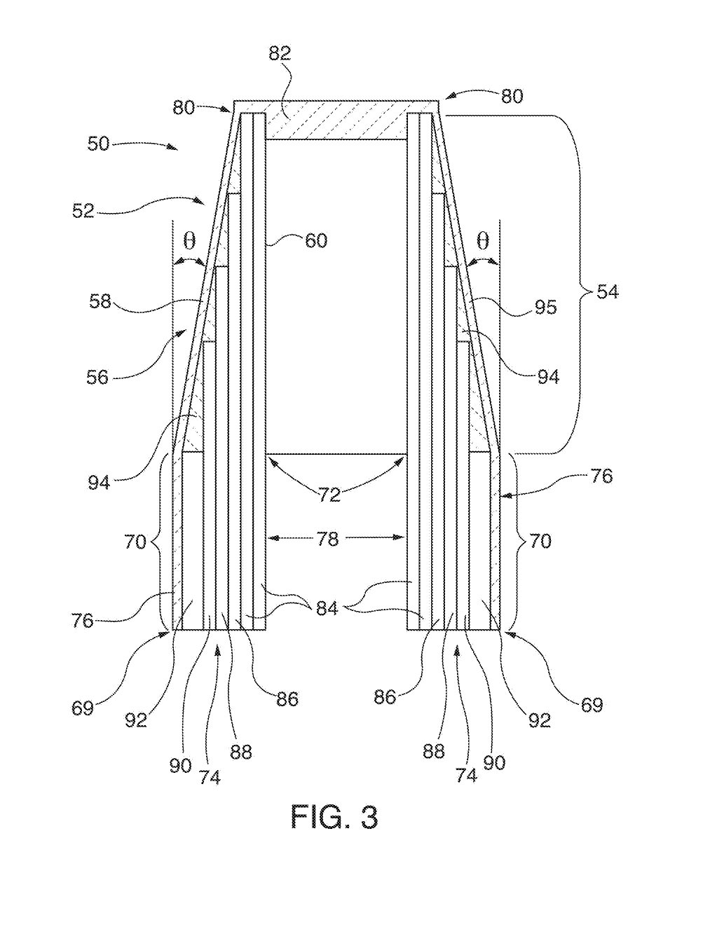

FIGS. 2 and 3 show an exemplary CMC turbine blade 50, for a combustion turbine engine. The CMC blade 50 has a fiber-reinforced, ceramic blade body 52, which includes an airfoil portion 54; with a tapered blade wall 56 defined between an outer wall surface 58 and an inner wall surface 60. The outer wall surface defines a concave pressure side 62, and a convex suction side 64, that are joined by a leading edge 66 and a trailing edge 68. A first end 69 of the blade body 52 defines a pair of blade shanks 70. In other embodiments the blade body, or alternatively a turbine vane, has at least one blade shank. As shown, each respective blade shank 70 has a shank first portion 72, which is proximate the airfoil portion 54, and a shank tip 74 distal the airfoil portion. First 76 and second 78 shank sides are oriented between the first portion 72 and distal tip 74 portion of the shank 70. When referring to blade shanks, such as the shank 70, the “axial direction” means along the blade shank from the leading edge 66 to the trailing edge 68 of the corresponding blade body 52. The “transverse direction” means from the first shank side 76 to the second shank side 78. A second end or tip portion 80 of the blade body 52 is coupled to a blade tip cap 82. Blade wall thickness in the airfoil portion between the outer 58 and inner 60 wall surfaces decreases axially along the blade length from the first end 69 to the second end 80 of the blade body 52.

Referring to FIG. 3, the CMC blade body 52 has a solidified, fiber-reinforced ceramic substrate, with ceramic fibers embedded therein. The blade body 52 includes a layered structure of laid-up ceramic fibers embedded within cured ceramic material, including at least one inner layer 84, which delimits the inner wall surface 60, the inner layer 84 has a length that extends from each blade shank distal tip 74 of the first end 69 of the blade body 52 to the second end 80 of the blade body, and successively shorter length extending layers 86, 88, 90, 92, that are applied over previously laid-up layers. Each successively shorter length layer extends from the distal tip 74 of each blade shank 70 of the blade body 52, toward the second end 80 thereof, so that thickness of the composite, laid-up, successive fiber layers 84, 86, 88, 90, 92 decreases from the first end 69 to the second end 80 of the blade body 52, because the successively shorter length layers do not extend as far toward the blade tip as the underlying layers.

The CMC blade 50 wall taper angle θ, including the number of reinforcing ceramic fiber layers and varying horizontal, cross-sectional thickness, is selected so that sufficient material tensile strength is provided to resist the centrifugal load CF imparted on the spinning blade. Generally, blade taper angle θ for a CMC blade will be about double comparable to the taper angle used in a superalloy blade. The taper angle θ for the CMC blade 50 is five degrees or greater, whereas a comparable taper angle for a superalloy blade is two-three degrees. Use of a pair of blade shanks 70 splits the total tensile load, that must be carried by each shank, safely within the material properties of the CMC material. One blade shank is on the pressure side 62 of the blade and the other blade shank is on the suction side 64 of the blade, as shown in FIG. 2. Lateral or circumferential distance between the blade shanks 70 is constrained by total allowable circumferential foot print or surface area allocated to each blade 50 within a given rotor disc 46 of the engine 20.

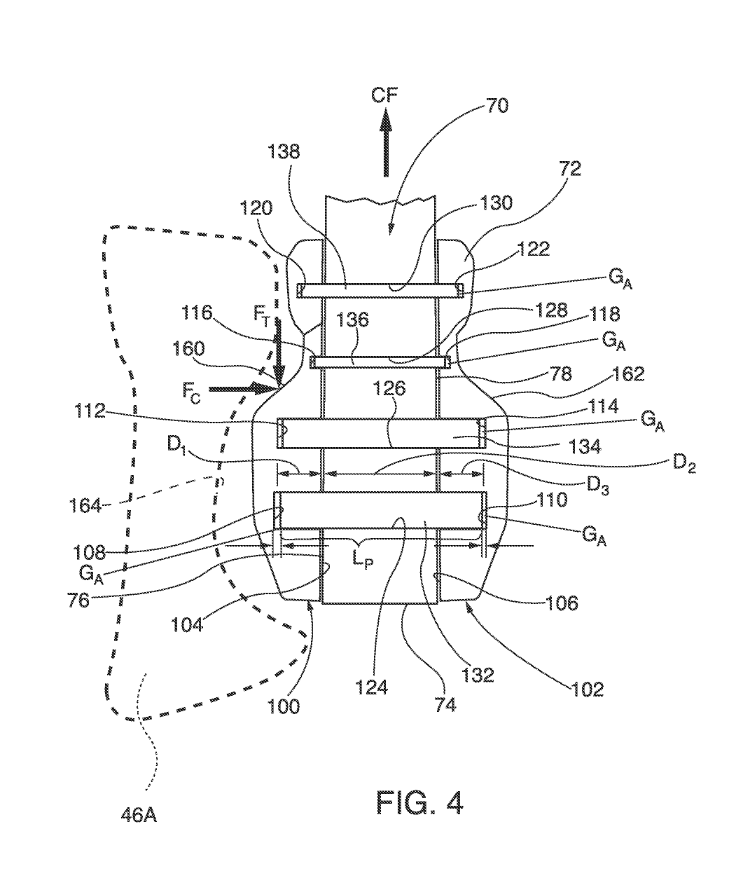

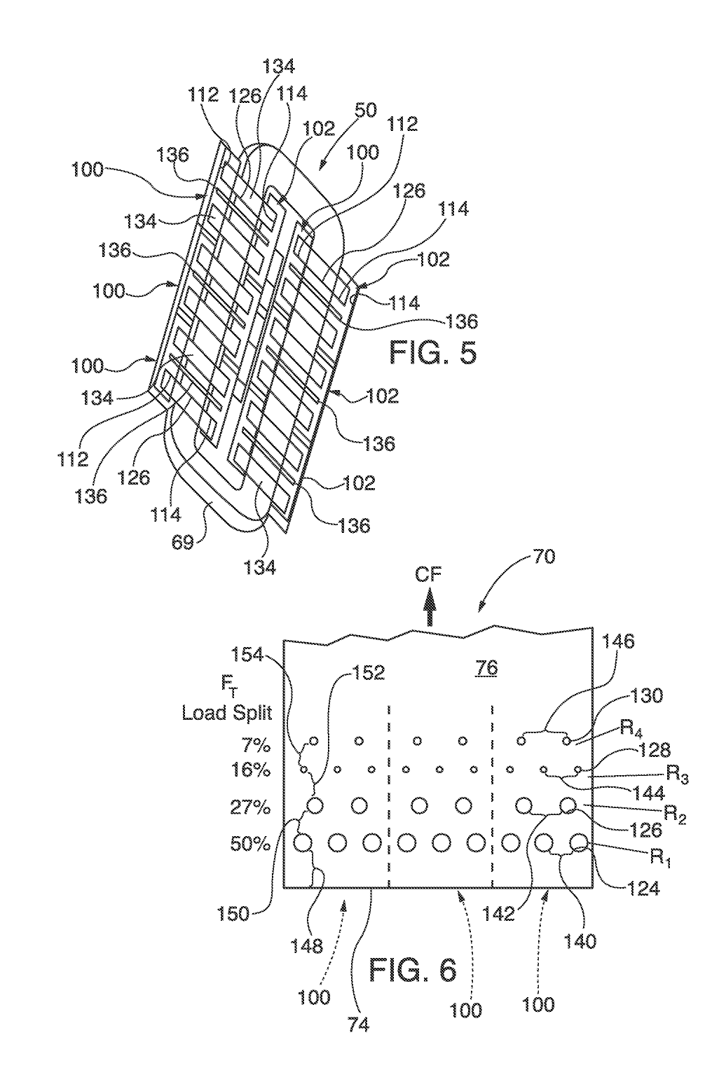

As shown in FIGS. 4 and 5, the blade shank 70 is pinned to a pair of first and second metallic clevis attachment pieces 100, 102, which respectively have an inner side 104, 106, with a profile conforming to that of a respective first and second shank side 76, 78. The respective inner sides 104, 106 of the first and second clevis attachment pieces 100, 102 have respective two-dimensional array of rows of partial-depth apertures 108, 110, 112, 114, 116, 118, 120, 122, which correspond to through-apertures 124, 126, 128, 130 formed in the blade shank 70. Load-carrying pins 132, 134, 136, 138, are captured, in clevis pin-like fashion, within the aforementioned apertures of the two-dimensional arrays of apertures formed in the blade shank 70 and the inner sides 104, 106 of the first and second clevis attachment pieces 100, 102. The load-carrying pins respectively have outer diameters corresponding to diameters of the aforementioned capturing apertures.

Each load-carrying pin (e.g., pin 132) respectively has an axial length L_{P} between its first and second pin ends that is shorter than combined axial depth D₁+D₂=D₃ of corresponding apertures (e.g., apertures 108, 124 and 110) that are formed in the blade shank 70 and the inner sides 104, 106 of the first and second clevis attachment pieces 100, 102. Because of the defined carrying-pin length and aperture depth dimensions, clearance gaps G_{A} are formed pin ends and the corresponding bottom depths of the partial-depth apertures. See for example, the ends of load carrying pin 132 and their interface with the corresponding partial-depth apertures 108, 110. When a compressive load force F_{C} is applied to the clevis attachment pieces 100, 102, the pin ends of the respective load-carrying pins (e.g., 132) bottom out against the corresponding partial-depth apertures (e.g., 108, 110), closing the gap G_{A} while concurrently compressing the CMC material in the blade shank 70. Generally, a compressive load on the CMC material in the blade shank 70 enhances ability of the material to carry tensile loads, so long as the compression force is below that which causes delamination of the ceramic fibers embedded within the blade shank. Advantageously, the gap G_{A} is chosen to be smaller than that which would enable application of a delamination compressive force on the blade shank 70.

Referring to FIGS. 2, 4 and 7, each of the metallic clevis attachment pieces 100, 102 respectively has an outer side 160, 162 that defines a tooth profile for slidable mating engagement with a corresponding turbine-blade engagement recess 164 of a turbine rotor disc 46A. Advantageously, the toothed profile of the outer sides 160, 162 of the clevis attachment pieces 100, 102 are formed to be compatible with existing types of fir-tree, blade-root attachment profiles that are utilized with superalloy metal blades. In this way, a ceramic material blade body 52 is successfully coupled to a turbine rotor disc 46 by way of the intermediate, clevis attachment pieces 100, 102. Clevis pin-like attachment of the blade shank 70 of the CMC blade 50 mates the relatively lower strength ceramic material, which is not sufficiently strong to form a workable fir-tree root, with metallic clevis pin attachment pieces 100, 102 and metallic load-carrying pins 132, 134, 136, 138. The metallic pieces collectively have sufficient strength to form a metallic outer surface of a blade root that is compatible with the mating recess 164 in the rotor disc 46A. The bottoming-out load-carrying pin length L_{P} restricts maximum compression of the CMC material blade shank 70 to the gap width GA, which enhances tensile load FT carrying capability of the ceramic blade 50 in response to applied centrifugal loads CF.

Some CMC blade 50 embodiments, such as those shown in FIGS. 2-9, incorporate a two-dimensional array of rows R₁, R₂, R₃, R₄ of respective apertures, 124, 126, 128, 130 formed in the blade shanks 70. Each of the apertures 124, 126, 128, 130 in these embodiments is a through-aperture, which extending through the corresponding blade shank 70 between the first 76 and second 78 shank sides thereof, for insertion and receipt of corresponding load-carrying pins 132, 134, 136, 138. As shown in FIGS. 4-6, rows of apertures formed in the blade shank 70 closer to or proximate to the distal tip 74 (e.g., 124 or 126) have larger diameters than said rows of apertures (e.g., 128, 130) formed closer to or proximate to the first portion 72 of the blade shanks 70. Diameter dimensions of the apertures 124, 126, 128, 130, those of their corresponding load-carrying pins 132, 134, 136, 138, as well as dimensions of the shank-forming, horizontal web material 140, 142, 144, 146 between columns, and the corresponding dimensions of the vertical web material 148, 150, 152, 154 between rows of those apertures are chosen, so that:
when an axial tensile load (such as the centrifugal force CF imparted on the rotating CMC blades 50) is applied to the blade shanks 70, the applied tensile load FT within the material forming the respective blade shanks 70, is distributed, so that in some embodiments the net section stress between any first pair of adjoining apertures in any row R₁-R₄ is within plus or minus twenty-five percent, and in other embodiments preferably within plus or minus five percent, of net section stress of any second pair of adjoining apertures in any other row R₁-R₄ (“net section stress” (f) is defined herein as magnitude of the applied tensile load (F_{T}), divided by the cross-sectional area (A) of material that is normal, i.e., 90 degrees, to the load, or f=F_{T}/A); and
the applied tensile load F_{T} stress in the shank 70 material is split between successive rows R₁-R₄ of apertures from proximate the shank distal tip 74 to its corresponding first portion 72, so that each row, R₁-R₄, of apertures 124, 126, 128, 130 carries its own tensile load, plus the aggregate tensile load of all other rows of apertures there above that are closer to the blade shank first portion 72. For example, in the blade shank 70 embodiment of FIG. 6, the tensile load FT is split between respective rows, R₁-R₄, of the apertures, such that the largest aperture row 124 carries approximately 50%, the aperture row 126 carries 27%, the aperture row 128 carries 16%, and the aperture row 130 carries 7% of the total applied tensile load.

As shown in FIG. 6, respective rows R₁-R₄ of apertures are staggered in the blade shank 70, so that no pair of apertures in any successive row is axially aligned. This increases vertical web material 148, 150, 152, 154 thickness between rows of apertures, reducing likelihood of material rupture in the vertical direction proximate a pin interface.

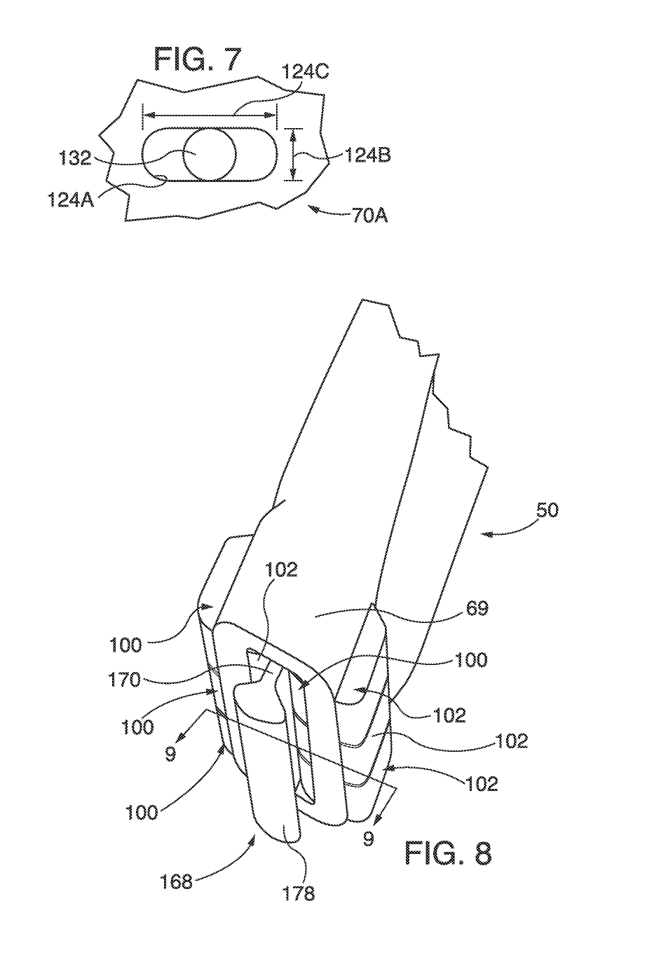

In some embodiments, provisions are made for mismatched thermal expansion in the axial direction of the blade shank 70, between the blade 50 leading edge 66 and trailing edge 68, through use of separate, parallel clevis attachment pieces 100, 102, as shown in FIGS. 2, 5 and 6. A gap between each adjoining clevis attachment piece 100 or 102 on the same side of the blade shank 70 gives each clevis piece sufficient space for thermal expansion (i.e., in the axial direction of the shank from leading to trailing edge of the blade 50), without imparting a shear stress in the axial direction from the leading edge 66 to trailing edge 68 of the blade 50. In the alternative, as shown in FIG. 7, if clearance spaces are not provided between adjoining clevis attachment pieces or if monostructural clevis- attachment pieces are utilized, the blade shank 70A incorporates elongated profile through-apertures, such as the aperture 124A. The elongated aperture 124A has a shorter axis 124B oriented axially from the blade shank 70 to the blade tip 82, while the longer axis, oriented axially from the leading edge 66 to the trailing edge 68 of the blade, allows relative axial motion between the pin 132 and the through aperture 124A, for thermal expansion mismatch compensation. Alternatively, the clevis attachment pieces 100, 102 may incorporate elongated partial-depth apertures, or both the blade shank 70A and the clevis attachment pieces incorporate such elongated aperture profiles. Alternatively, both the blade shank 70A and the clevis attachment pieces 100, 102 may incorporate such elongated aperture profiles. Additional thermal expansion mismatch is accommodated by the teeth formed on the outer surfaces 160, 162 of the clevis attachment pieces 100, 102 sliding along the mating dovetail engagement with the rotor disc recess 164.

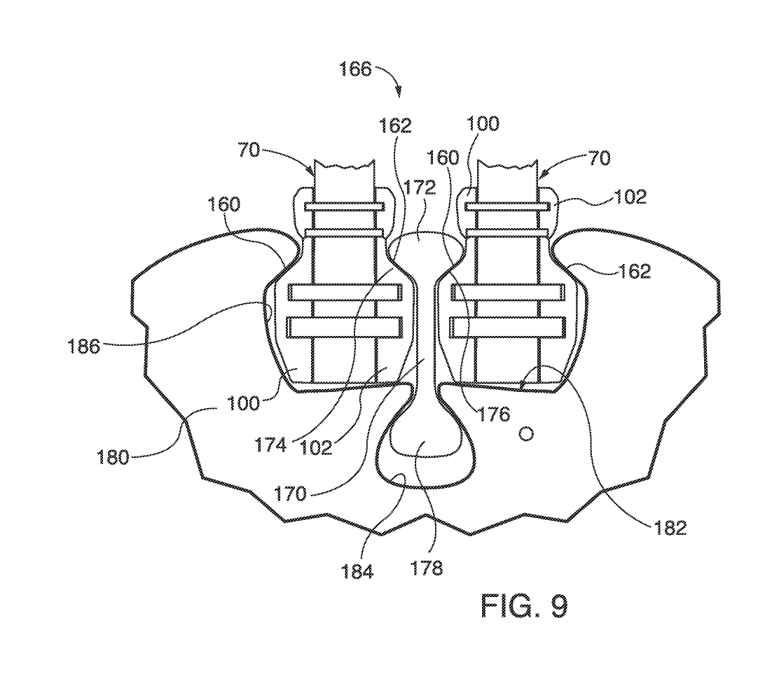

In the embodiments of FIGS. 8 and 9, a dog bone-like attachment system 166 couples the CMC blade 50 to a rotor disc 180 having a fir-tree recess 182, of a known configuration, previously used for attachment of metallic turbine blade roots. The fir-tree recess 182 has a lower zone 184 and an upper zone 186. The dog bone attachment system 166 includes a dog bone 168, including a central spine 170, a bulbous-shaped first end 172, with concave first and second faces 174, 176, having respective profiles which correspond to profile of a turbine blade-engagement, fir-tree profile upper zone 186 recess within the turbine rotor disc 180, for abutting engagement with respective, convex profile, opposed outer sides 160, 162 of inwardly-facing, clevis attachment pieces 100, 102. The dog bone 168 also has a bulbous-shaped, second end 178, for engagement with the lower zone 184, of the fir-tree recess 182 within the turbine rotor disc 180. The dog bone-like attachment system 166 facilitates coupling of a dual blade shank 70, CMC blade 50 within a known fir-tree recess 182 within a rotor disc 180. The dog bone-like attachment system 166 can be utilized to couple any other type of dual-shank blade, constructed of any material, to a fir-tree recess 182 having a lower zone 184 and an upper zone 186. Specifically, use the dog bone-like attachment system 166 is not restricted to any particular blade or blade shank construction. More specifically, the dog bone-like attachment system 166 is not restricted use with any specific turbine blade embodiment described herein.

In accordance with method embodiments of the invention, exemplary CMC turbine blades 50, (as well as similar construction CMC vane components) are made by laying-up the ceramic fiber layers 84, 86, 88, 90, 92 into the layered, tapered structure, to form the blade body 52. In some CMC blade manufacture embodiments, innermost fabric layers 84 of the laid-up fibers extend in length from a distal end 74 of the to-be-formed blade shank 70 of the blade body 52 to the juncture with the blade tip 82. Subsequently applied, outboard fabric layers 86, 88, 90, 92 are laid-up to extend from the blade shank distal end 74 in progressively shorter lengths toward the blade tip 82. In this way, the blade wall structure is thicker proximate the blade shank 70, where it is attached to a corresponding rotor disc 46, and tapers to a thinner wall structure proximate the blade tip 82. After laying up the ceramic fibers (e.g., the fabric layers 84, 86, 88, 90, 92) they are impregnated with ceramic slurry material, if those fibers were not previously impregnated with ceramic material prior to their lay-up. The impregnated ceramic fibers are cured, thereby solidifying the ceramic CMC material 94, which forms the blade body 52. In some embodiments, a thermal barrier coating (“TBC”) outer insulative layer 95 is applied over the solidified CMC material 94 of the blade body 52. In some embodiments, the TBC layer is applied to the blade shanks 70. In exemplary embodiments, the TBC layer 95 is thermally sprayed, vapor deposited, or solution/suspension plasma sprayed over the outer wall surface 58 of the blade body 52.

In some embodiments, a clevis pin-like attachment system is incorporated into CMC vanes for turbine engines. The CMC vane mounting system is constructed, in the alternative, with or without the two-dimensional array of attachment pins within an attachment shank that was previously described for application with the CMC turbine blade 50 embodiments. Typically a CMC turbine vane will have shanks at both ends of the vane body, outboard of the vane airfoil. In this way, a CMC structure vane body is mated to metallic support structure of a corresponding turbine vane cavity.

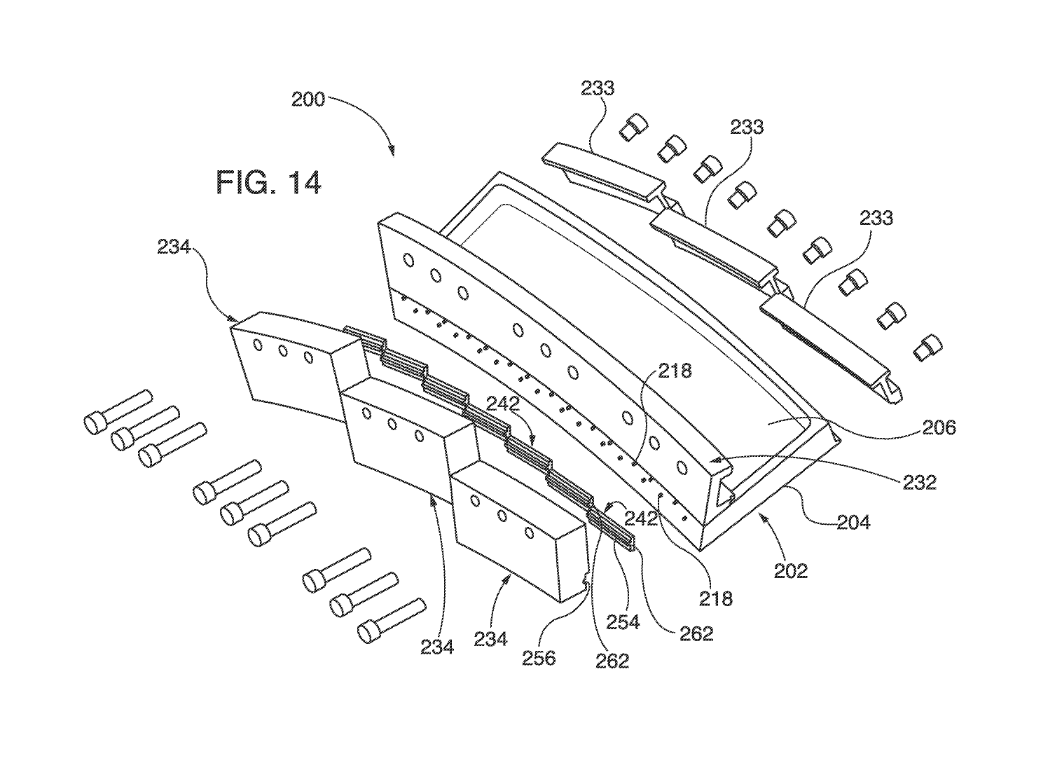

Ring segment mounting system embodiments, which incorporate clevis pin-type mounting structures, are shown in FIGS. 1, and 10-22. FIGS. 1 and 10-14 show a first embodiment of a ring segment mounting system 200, which is mounted in the casing ring 48 of the combustion-turbine engine casing 22 of the engine 20. The casing ring 48 circumscribes the rotating turbine blades 42. The casing ring 48 comprises a plurality of circumferentially abutting, annular ring segments 202, which are all retained within the engine casing 22. Each ring segment 202 includes an inner circumferential surface 204, which is exposed to combustion gasses, an outer circumferential surface 206, which is directly or indirectly in thermal communication with pressurized cooling air, forward 208 and aft 210 axial ends. A circumferentially aligned forward lug forms a first flange 212, which projects radially away from the outer circumferential surface 206. The first flange 212 has a forward axial side 214, as well as an aft axial side 216. While the ring segment first flange 212 is shown as a continuous, solid flange, in alternative embodiments, the first flange is segmented, where individual sub-flanges are isolated from each other, in order to avoid circumferential transfer of mechanical or thermal stresses to other sub-flanges. The first flange 212 is oriented proximate the forward axial end 208 of the ring segment 202, while a corresponding aft lug 217 is oriented proximate the aft axial end 210 of the ring segment.

An array of first apertures 218 pass entirely through forward 214 and aft 216 axial sides of the first flange 212; i.e., they are through-apertures. The respective first apertures 218 slidably receive corresponding ones of a plurality of mounting pins 220. Each of the mounting pins 220 has a forward 224 and an aft 226 distal end or tip, which tips respectively extend or project outwardly from both forward 214 and aft 216 axial sides of the first flange 212. The ring segment mounting system 200 includes a ring-segment support ring 230 that is coupled to the combustion-turbine engine casing 22. The ring-segment support ring 230 has a forward isolation ring 232, an aft isolation ring 233, and a plurality of circumferentially aligned vane blocks 234. The forward isolation ring 232 forms a second flange, and the vane blocks 234 collectively form a third flange. The second flange i.e., the forward isolation ring 232 and the third flange (i.e., the vane blocks 234) are circumferentially aligned with the first flange 212 of the ring segment 202. Both the second 232 and the third 234 flanges radially project inwardly toward the outer circumferential surface 206 of the ring segment 202, and respectively are rigidly oriented in spaced, axially opposed, circumferentially flanking relationship with corresponding forward 214 and aft 216 axial sides of the first flange 212, in clam shell-like fashion, establishing axial spacing gaps “g” there between.

The second 232 and third 234 flanges of the ring-segment support ring 230 having respective second 236 and third 238 partial-depth apertures, which are coaxially aligned in opposing corresponding relationship with the first through-apertures 218 of the first flange 212, and which respectively receive corresponding forward 224 and aft 226 ends of the mounting pins 220. The second 236 and third 238 partial-depth apertures constrain radial movement of the mounting pins 220, as is done in a clevis pin-type mounting system. Radial constraint of the respective mounting pins 220 in turn radially constrains each pin's corresponding ring segment 202 within the combustion-turbine engine casing 22, by way of the slidable engagement with a corresponding first through-aperture 218. While the slidable engagement between the mounting pin 220 and the first flange 212 constrains radial movement of the ring segment 202, it allows axial movement of the ring segment 202 within the engine casing 22, by relative sliding motion of the respective first apertures 218 along their respective mounting pins 220. The axial movement accommodates thermal mismatch relative expansion between the ring segment 202 and the engine casing 22 in the general direction of the engine 20 from the compressor section 24 to the turbine section 28.

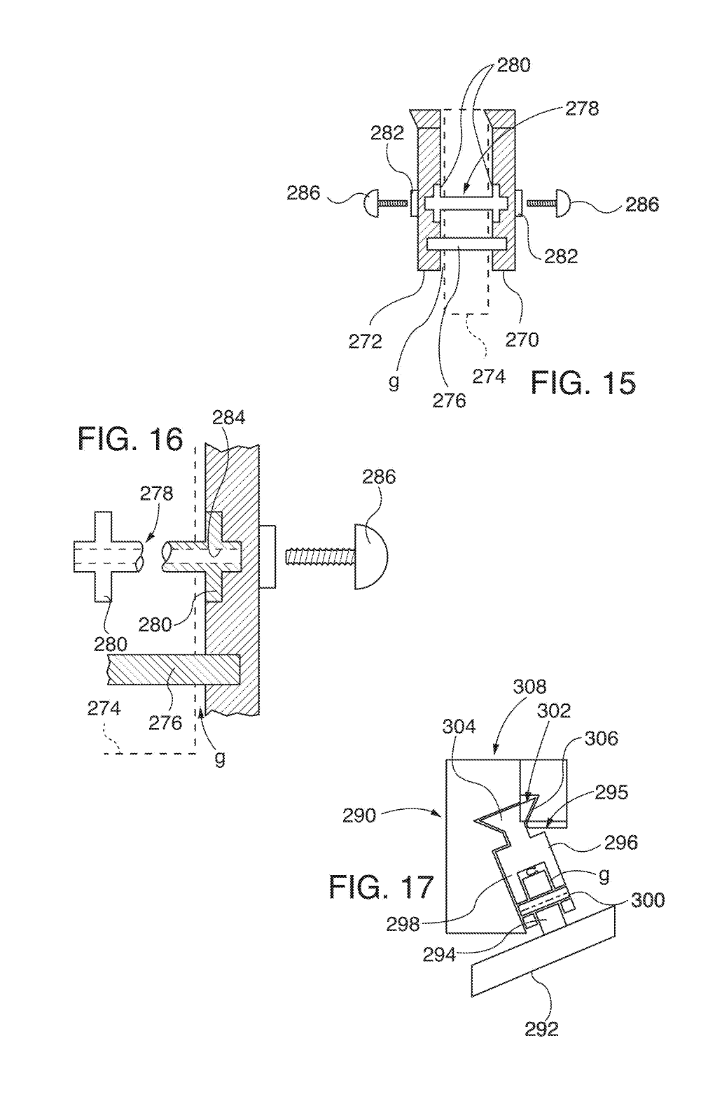

In the ring segment mounting system embodiment of FIGS. 10-14, the aft lug 217 of the ring segment 202 is rigidly coupled to the aft isolation ring 233, which in turn is rigidly coupled to the engine casing 22. The forward isolation ring 232 and the aft isolation ring 233 respectively include hook portions, which are coupled to the engine casing 22. As the forward 232 and aft 233 isolation rings are rigidly coupled to the engine casing 22 in the axial direction, axial expansion and contraction range of the ring segment in response to thermal mismatch conditions is constrained within limits of the gap “g” that exists between the second flange of the isolation ring 232 and the third flange of the vane blocks 234. As shown schematically in FIG. 15, the gap “g” is established by making the axial length 1ₚ of the mounting pin 220 longer than the combined depths d₁+d₂+d₃ of the partial-depth second 236 and third 238 apertures and the first through-aperture 218.

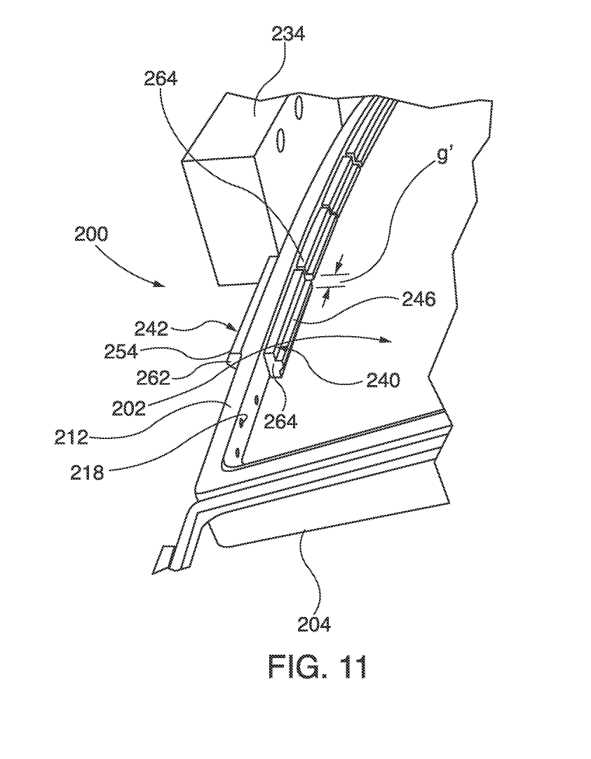

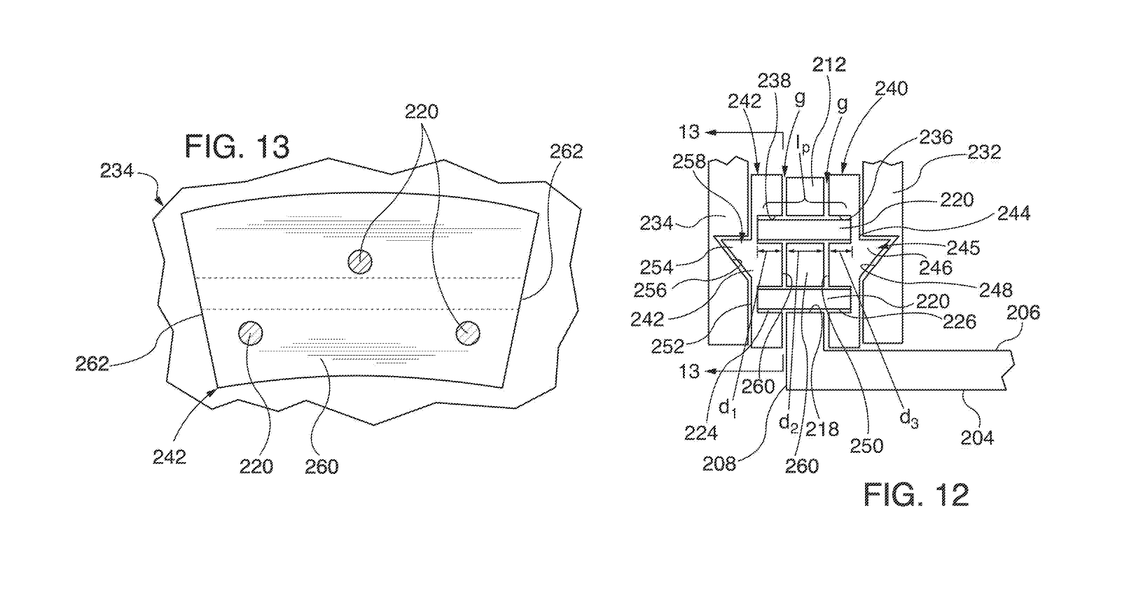

The ring segment mounting system embodiment of FIGS. 10-14 also provides for, and accommodates, a second range of thermal mismatch expansion between the ring segment 202 and the support ring 230, in the circumferential direction of the engine casing 22. Referring to the schematic FIGS. 12 and 13, the circumferential expansion range of motion is provided by second 245 and third 258 dovetail-like circumferential joints, which are respectively formed among first 240 and second 242 pin-retaining pieces, the second flange formed in the forward isolation ring 232 and the third flange formed in the vane blocks 234. In some embodiments, the dovetail angle varies from 30 degrees to 90 degrees. As shown in FIGS. 11 and 12, each of the respective pin-retaining pieces 240, 242 have sector-shaped profiles, and are circumferentially spaced from adjoining pin-retaining pieces by a gap “g′”, for thermal expansion spacing. The respective pin-retaining pieces 240, 242 receive ends of the corresponding mounting pins 220, forming the previously described clevis pin-type mounting structure for the ring segment 202. The second 245 and third 258 dovetail mating joints allow circumferentially-directed movement of the ring segment 202 within the engine casing 22 by relative sliding motion of the respective first 240 and second 242 pluralities of pin-retaining pieces within their respective second and third dovetail mating joints within the confines of the circumferential gaps “g′” between laterally adjoining, circumferentially-spaced, pin-retaining pieces.

The first pin-retaining piece 240 is captured within the second flange formed within the forward isolation ring 232, and interposed between aft side 216 of the first flange 212 of the ring segment 202 and said forward isolation ring. The first pin-retaining piece 240 has an outboard side 244 that defines a second portion 246 of the second dovetail mating joint 245, which is in slidable, mating engagement with a circumferential groove 248 formed within the second flange formed within the forward isolation ring 232. The circumferential groove 248 forms a first portion of the second dovetail mating joint 245. An inboard side 250 defines the second, partial-depth apertures 236, which receive the aft-projecting pin end 226 of the corresponding mounting pin 220. Circumferential sides 264 defined by each of the respective first pin-retaining pieces 240 are laterally/circumferentially spaced from neighboring first pin-retaining pieces by the gap “g′“.

Similarly, the second pin-retaining piece 242 is captured within the third flange formed within the vane blocks 234, and interposed between the forward side 214 of the first flange 212 of the ring segment 202 and said vane blocks. The second pin-retaining piece 242 has an outboard side 252 that defines a second portion 254 of the third dovetail mating joint 258, which is in slidable, mating engagement with a circumferential groove 256 formed within the third flange formed within the vane blocks 234. The circumferential groove 256 forms a first portion of the third dovetail mating joint 258. An inboard side 260 defines the third, partial-depth apertures 238, which receive the forward-projecting pin end 224 of the corresponding mounting pin 220. Circumferential sides 262 defined by each of the respective second pin-retaining pieces 242 are laterally/circumferentially spaced from neighboring second pin-retaining pieces by the gap “g′“.

FIGS. 15 and 16 show an alternative embodiment of clevis pin-type mounting system, with first 270 and second 272 pin-retaining pieces retaining the ring segment first flange 274 with a combination of a plain, cylindrical mounting pin 276, which engages in partial depth apertures as previously described for the embodiments of the mounting pins 220 in FIGS. 12 and 13, and a shouldered mounting pin 278. Shoulders 280 of the shouldered mounting pin 278 engage in recessed, respective second and third apertures formed within the respective first 270 and second 272 pin-retaining pieces, which restrict insertion depth of the mounting pin, and thus maintain the spacing gap “g”. The shouldered mounting pin 278 prevents inward collapse of the first 270 and second 272 pin-retaining pieces during engine 20 assembly. After orientation of the shouldered mounting pin 278 relative to the respective second and third apertures of the first 270 and second 272 pin-retaining pieces, washers 282 are coaxially aligned with apertures 284 formed in the pin, and a fastener 286 is inserted into the mounting pin apertures 284. Exemplary fasteners 286 include rivets, one-way insertable fasteners and threaded fasteners. Once the fasteners 286 are coupled to ends of the shouldered mounting pin 278 they prevent separation of the first 270 and second 272 pin-retaining pieces. Alternative ways to prevent separation of the previously described pin-retaining piece embodiments 240, 242, 270 and 272 from the mounting pins 220 or 276 include, without limitation, brazing, gluing, staking or press-fitting the pins into the corresponding pin-receiving apertures of the pin-retaining pieces or other forms of second or third flanges.

Alternative embodiments of clevis pin-type, mounting systems for ring segments are shown in FIGS. 17-22. The ring-segment mounting system 290 of FIG. 17 retains the ring segment 292 by coupling its first flange 294 to a unitary clevis structure 295, having integrally formed second 296 and third 298 flanges by the mounting pin 300. The first flange 294 slidably engages the mounting pin 300, and is movable within the gap “g”. A circumferentially oriented dovetail joint 302 provides a circumferential range of motion for thermal expansion accommodation. A first portion 304 is formed in the unitary clevis structure 295 and the dovetail second portion 306 is formed in the engine casing 308. The mounting system 290 is pre-assembled outside the engine prior to installation in the turbine engine.

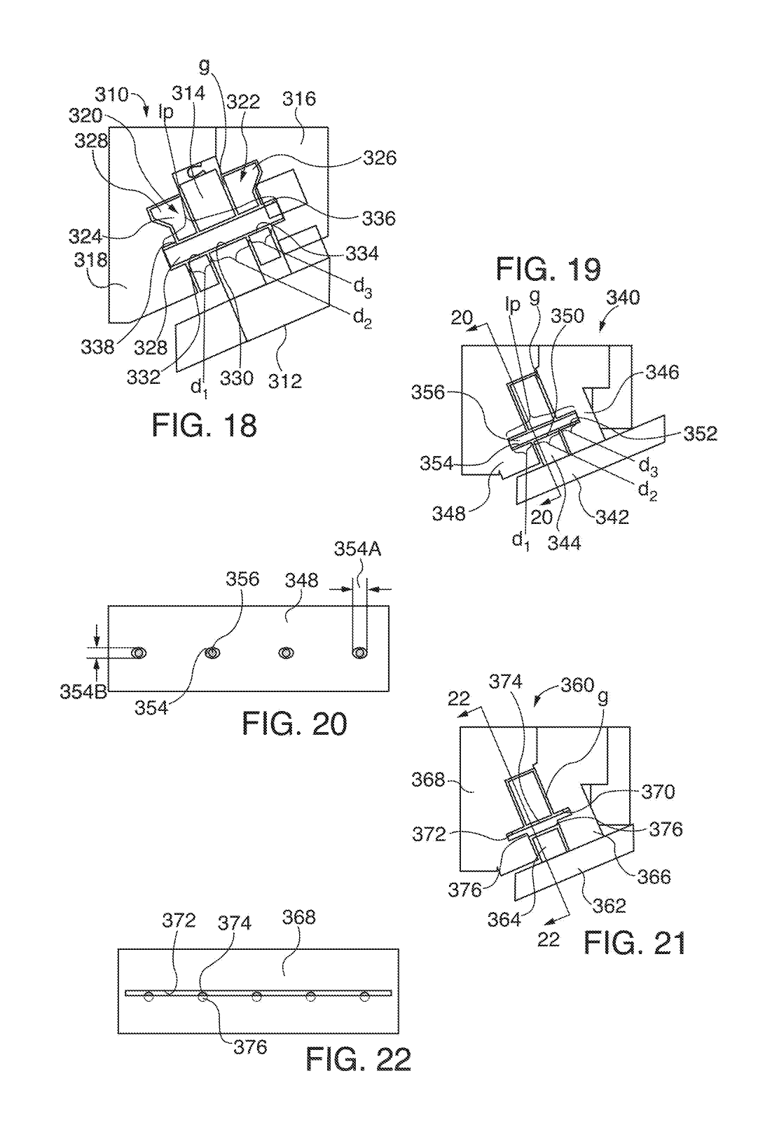

The ring-segment mounting system 310 of FIG. 18 has a two-piece clevis structure that retains the ring segment 312 by coupling its first flange 314 to second 316 and third 318 flanges by respective first 320 and second 322 pin-retaining pieces. Respective first dovetail and second portions 324, 326 are formed in the first 320 and second 322 pin-retaining pieces. Mounting pin 328 is slidably retained in coaxially aligned first 330, second 332 and third 334 through-apertures. Respective projecting ends of the mounting pin 328 are radially restrained in and axially bottomed out in first 336 and second 338 circumferential grooves. The grooves 336 and 338 are respectively formed in second 316 and third 318 flanges. The first flange 314 is slidable along the mounting pin 328 within the gap “g”, for thermal expansion in the axial direction, while the dovetailed joints in the first 320 and second 322 pin-retaining pieces accommodate thermal expansion in the circumferential direction.

The ring-segment mounting system 340 of FIGS. 19 and 20 provides axial thermal mismatch expansion in gap range “g”, similar to the mounting system 310 of FIG. 18, and circumferential thermal mismatch expansion by use of elongated apertures. The ring segment 342 has a first flange 344, coupled by clevis pin-type mounting to the respective second 346 and third 348 flanges, by coaxial alignment of a first through-aperture 350 with circumferentially-elongated, corresponding second 352 and third 354 apertures, and subsequent insertion of the mounting pin 356. As shown in FIG. 20, the exemplary third aperture 354 has second and third aperture profiles, with a longer axis 354A oriented circumferentially relative to the turbine casing, and a shorter axis 354B that is oriented radially relative to the turbine engine casing. The elongated second 352 and third 354 apertures respectively allow circumferential movement of the ring segment 342 within the corresponding engine casing 22 of FIG. 1, by relative sliding motion of the respective mounting pins 356 along the longer axis (e.g., 354A) of each of said respective corresponding, elongated second 352 or third aperture 354.

The ring-segment mounting system 360 of FIGS. 21 and 22 provides both axial and circumferential expansion capabilities to the ring segment 362 in a manner that is similar to those of FIGS. 19 and 20. Ring segment 362 has a first flange 364 that is captured between the second 366 and third 368 flanges formed in the turbine engine casing. Either or both of the second 366 and third 368 flanges define respective second 370 and third 372 apertures, which formed as a continuous circumferential groove within its respective second or third flange. Forward and/or aft ends of the respective mounting pins 374 are slidable within their corresponding circumferential groove 370 or 372, respectively allowing circumferential, sliding movement of the ring segment 362 within the turbine engine casing. The axially extending shoulder 376 establishes axial spacing between the second 366 and third 368 flanges. Gap “g” is established by making axial thickness of the first flange 364 smaller than the length of the axially extending shoulder.

Although various embodiments that incorporate the invention have been shown and described in detail herein, others can readily devise many other varied embodiments that still incorporate the claimed invention. The invention is not limited in its application to the exemplary embodiment details of construction and the arrangement of components set forth in the description or illustrated in the drawings. The invention is capable of other embodiments and of being practiced or of being carried out in various ways.

By way of non-limiting examples, while cross-sectional profiles of mounting and retaining pins and their corresponding receiving apertures, in different types of clevis pin-like mounting systems shown in the figures, are circular, other cross sectional profiles can be substituted for the circular profiles. A threaded fastener, such as a cap screw, can be substituted for one or more of the dowel-like, cylindrical profile, mounting and retaining pins. Similarly, non-oval, elongated apertures can be substituted for oval profile apertures. Flanges of blade or vane shanks, as well as flanges on casing rings, ring segments, and ring segment supports can have continuous circumferential profiles, as shown, or such flanges can comprise sub arrays of segmented or split sub-flanges. While some blade and vane embodiments are described as having CMC material construction, the clevis pin-type mounting systems shown and claimed herein can be utilized with metallic vanes or blade bodies.

In some embodiments, if a threaded fastener is utilized for a mounting or retaining pin, one or more of the pin-receiving apertures in the clevis attachment pieces or the second or third flanges of a ring segment support can be constructed with corresponding female threads, for engagement of the fastener's male threads. Concomitantly, the blade shank or ring segment flange aperture slides over the outer diameter, thread profile of the male threads of the fastener.

In some embodiments, the outer profile of the clevis-attachment pieces forms the outer profile of a blade platform. In some other embodiments, the blade platform defined by the clevis-attachment pieces is subsequently coated with a thermal barrier coating.

In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted”, “connected”, “supported”, and “coupled”, and variations thereof are used broadly and encompass direct and indirect mountings, connections, supports, and couplings. Further, “connected” and “coupled” are not restricted to physical, mechanical, or electrical connections or couplings.

What is claimed is:

1. A ceramic-matrix-composite (CMC) blade for a combustion turbine engine, comprising:
a fiber-reinforced, ceramic blade body, which includes: an airfoil portion with a tapered blade wall defined between an outer wall surface and an inner wall surface, the outer wall surface defining respective concave pressure and convex suction sides joined by leading and trailing edges; a first end defining at least one blade shank, the at least one blade shank having a shank first portion proximate the airfoil portion, a shank tip distal the airfoil portion, and first and second shank sides between the first and tip distal portions thereof; and a second end coupled to a blade tip; with blade wall thickness in the airfoil portion between the outer and inner wall surfaces decreasing from the first end to the second end of the blade body;
the blade body including a layered structure of laid-up ceramic fibers embedded within cured ceramic material, including at least one inner layer, which delimits the inner wall surface, the inner layer having a length extending from the at least one blade shank distal tip of the first end of the blade body to the second end of the blade body, and successively shorter length extending layers, applied over previously laid-up layers, each successively shorter layer having a length extending from the at least one blade shank distal tip of the first end toward the second end thereof, so that thickness of the composite, laid-up, successive fiber layers decreases from the first end to the second end; and
a two-dimensional array of rows of apertures formed in the at least one blade shank, each of said apertures extending through the at least one blade shank between the first and second shank sides thereof, for insertion and receipt of corresponding load-carrying pins, with rows of said apertures formed proximate the distal tip thereof having larger diameter than said rows of apertures formed proximate the first portion of the at least one blade shank, so that when any axial tensile load is applied to the at least one blade shank while corresponding load-carrying pins are inserted into their respective apertures, the applied tensile load is distributed within the material forming the at least one blade shank, such that applied tensile load stress is split between successive rows of apertures from proximate the at least one blade shank distal tip to its corresponding first portion, so that each row of apertures carries its own tensile load plus aggregate tensile load of all other rows of apertures that are closer to the blade shank first portion.

2. The CMC blade of claim 1, the two-dimensional array of rows of apertures formed within the at least one blade shank comprising respective staggered rows of apertures, with no third pair of apertures in any successive rows in axial alignment between the distal and first portion thereof.

3. The CMC blade of claim 1, further comprising a pair of first and second blade shanks, the first blade shank proximate the pressure side of the blade body, and the second blade shank proximate the suction side of the blade body.

4. The CMC blade of claim 1, the blade wall having a taper angle of five degrees or greater, such that blade wall thickness in the airfoil portion between the outer and inner wall surfaces decreases from the first end to the second end of the blade body.

5. The CMC blade of claim 1, further comprising:
a pair of first and second clevis attachment pieces, respectively having an inner side with a profile conforming to that of a respective first and second shank side of the at least one blade shank, the respective inner sides of the first and second clevis attachment pieces having a two-dimensional array of rows of partial-depth apertures which correspond to those formed in the blade shank, and respectively having an outer side with a profile for mating engagement with a corresponding turbine-blade engagement recess within a turbine rotor disc;
a plurality of load-carrying pins, respectively having outer diameters corresponding to diameters of apertures of the two-dimensional arrays of apertures formed in the blade shank and the inner sides of the first and second clevis attachment pieces, the pins respectively having pin axial length between first and second pin ends shorter than combined axial depth of corresponding apertures formed in the blade shank and the inner sides of the first and second clevis attachment pieces; and
the load-carrying pins captured within corresponding apertures formed in the blade shank and the inner sides of the first and second clevis attachment pieces.

6. The CMC blade of claim 5, further comprising a pair of spaced-apart, first and second blade shanks, the first blade shank proximate the pressure side of the blade body, and the second blade shank proximate the suction side of the blade body, each of the respective blade shanks coupled to a corresponding, respective first and second pair of said first and second clevis attachment pieces by a plurality of corresponding, respective first and second sets of said load-carrying pins.

7. The CMC blade of claim 6, further comprising:
respective outer sides of the respective first and second pairs of clevis attachment pieces defining a tooth profile for mating engagement with a corresponding turbine-blade engagement, fir-tree profile recess within a turbine rotor disc; and
a dog bone-shaped, central support, interposed between the spaced-apart, respective first and second blade shanks, the central support having:
a central spine portion;
a bulbous-shaped first end, with concave first and second faces having respective profiles which correspond to profile of a turbine blade-engagement, fir-tree profile recess within a turbine rotor disc, for abutting engagement with respective, convex profile, opposed outer sides of inwardly-facing, clevis attachment pieces; and
a bulbous-shaped, second end for engagement with a corresponding fir-tree profile, turbine-blade engagement recess within a turbine rotor disc.

8. The CMC blade of claim 7, further comprising respective pluralities of first and second clevis attachment pieces coupled to respective first and second shank sides of the respective first and second blade shanks, with thermal expansion gaps defined between each adjoining pair of attachment pieces on either of the first or second shank sides of the first and second blade shanks.

9. The CMC blade of claim 7, each of the apertures of the two-dimensional arrays of rows of apertures in at least one of the first and second blade shanks or in their respective first and second sets of respective first and second clevis attachment pieces, or in all of the aforementioned arrays of apertures, comprising elongated profiles, with a shorter axis oriented from the first end to the second end of the blade body, and a longer axis oriented from the leading edge to the trailing edge of the blade body.

10. The CMC blade of claim 5, further comprising respective pluralities of first and second clevis attachment pieces coupled to respective first and second shank sides of the at least one blade shank, with thermal expansion gaps defined between each adjoining pair of attachment pieces on either of the first or second shank sides of the at least one blade shank.

11. The CMC blade of claim 5, each of the apertures of the two-dimensional arrays of rows of apertures in the at least one blade shank, or in its respective first and second clevis attachment pieces, or in all of the aforementioned arrays of apertures, comprising elongated profiles, with a shorter axis oriented from the first end to the second end of the blade body, and a longer axis oriented from the leading edge to the trailing edge of the blade body.

12. A combustion turbine engine, which incorporates ceramic-matrix-composite (CMC) blades, comprising:
an engine casing, having a compressor section, a combustion section, and turbine section; a rotating rotor shaft in the engine casing, including a turbine rotor disc and a plurality of turbine blade-engagement recesses formed in the turbine rotor disc;
a row of a plurality of ceramic-matrix-composite (CMC) blades, respectively coupled to corresponding turbine blade-engagement recesses, each blade having:
a fiber-reinforced, ceramic blade body, which includes: an airfoil portion with a tapered blade wall defined between an outer wall surface and an inner wall surface, the outer wall surface defining respective concave pressure and convex suction sides joined by leading and trailing edges; a first end defining at least one blade shank, the at least one blade shank having a shank first portion proximate the airfoil portion, a shank tip distal the airfoil portion, and first and second shank sides between the first and tip distal portions thereof; and a second end coupled to a blade tip, with blade wall thickness in the airfoil portion between the outer and inner wall surfaces decreasing from the first end to the second end of the blade body;
the blade body including a layered structure of laid-up ceramic fibers embedded within cured ceramic material, including at least one inner layer, which delimits the inner wall surface, the inner layer having a length extending from the at least one blade shank distal tip of the first end of the blade body to the second end of the blade body, and successively shorter length extending layers, applied over previously laid-up layers, each successively shorter layer having a length extending from the at least one blade shank distal tip of the first end toward the second end thereof, so that thickness of the composite, laid-up, successive fiber layers decreases from the first end to the second end;
a two-dimensional array of rows of apertures formed in the at least one blade shank, each of said apertures extending through the at least one blade shank between the first and second shank sides thereof;
a pair of first and second clevis attachment pieces, respectively having an inner side with a profile conforming to that of a respective first and second shank side of the at least one blade shank, the respective inner sides of the first and second clevis attachment pieces having a two-dimensional array of rows of partial-depth apertures which correspond to those formed in the blade shank, and respectively having an outer side with a profile engaged within a corresponding one of said turbine-blade engagement recesses within the turbine rotor disc;
a plurality of load-carrying pins, respectively having outer diameters corresponding to diameters of apertures of the two-dimensional arrays of apertures formed in the blade shank and the inner sides of the first and second clevis attachment pieces, the pins respectively having pin axial length between first and second pin ends shorter than combined axial depth of corresponding apertures formed in the blade shank and the inner sides of the first and second clevis attachment pieces;
the load-carrying pins captured within corresponding apertures formed in the blade shank and the inner sides of the first and second clevis attachment pieces; and
the rows of said apertures formed proximate the distal tip of the at least one blade shank having larger diameter than said rows of apertures formed proximate the first portion of the at least one blade shank, so that when any axial tensile load is applied to the at least one blade shank during engine operation, the applied tensile load is distributed within the material forming the at least one blade shank between adjoining load-carrying pins, such that applied tensile load stress is split between successive rows of apertures and their respective load-carrying pins, from proximate the at least one blade shank distal tip to its corresponding first portion, so that each row of apertures and respective load-carrying pins carries its own tensile load plus aggregate tensile load of all other rows of apertures that are closer to the blade shank first portion.

13. The combustion turbine engine of claim 12, further comprising:
fir-tree profile, turbine blade-engagement recesses within a turbine rotor disc, respectively having a lower blade engagement zone, closer to a rotational centerline of the rotor shaft, and an upper blade engagement zone, closer to an outer circumference of the rotor disc;
a pair of spaced-apart, first and second blade shanks inserted within the corresponding fir-tree profile, turbine blade-engagement recess, the first blade shank proximate the pressure side of the blade body, and the second blade shank proximate the suction side of the blade body, each of the respective blade shanks coupled to a corresponding, respective first and second pair of said first and second clevis attachment pieces by a plurality of corresponding, respective first and second sets of said load-carrying pins;
respective outer sides of the respective first and second pairs of clevis attachment pieces defining a tooth profile in engagement with a corresponding upper zone of the corresponding fir-tree profile recess; and
a dog bone-shaped, central support, retained within each fir-tree profile, turbine blade-engagement recess, interposed between the spaced-apart, respective first and second blade shanks, the central support having:
a central spine portion;
a bulbous-shaped first end, with concave first and second faces, having respective profiles that are in abutting engagement with respective, convex profile, opposed outer sides of inwardly-facing, clevis attachment pieces of the first and second blade shanks; and
a bulbous-shaped, second end in engagement with a lower blade engagement zone of the corresponding fir-tree profile, turbine blade-engagement recess.

14. The combustion turbine engine of claim 13, further comprising respective pluralities of first and second clevis attachment pieces coupled to respective first and second shank sides of the respective first and second blade shanks, with thermal expansion gaps defined between each adjoining pair of attachment pieces on either of the first or second shank sides of the at least one blade shank.

15. The combustion turbine engine of claim 13, each of the apertures of the two-dimensional arrays of rows of apertures in the first and second blade shanks, or in their respective first and second sets of respective first and second clevis attachment pieces, or in all of the aforementioned arrays of apertures, comprising elongated profiles, with a shorter axis oriented from the first end to the second end of the blade body, and a longer axis oriented from the leading edge to the trailing edge of the blade body.

16. A method for manufacturing a ceramic-matrix-composite (CMC) blade for a combustion turbine engine, comprising:
fabricating a fiber-reinforced, ceramic blade body, which includes: an airfoil portion with a tapered blade wall defined between an outer wall surface and an inner wall surface, the outer wall surface defining respective concave pressure and convex suction sides joined by leading and trailing edges; a first end defining at least one blade shank, the at least one blade shank having a shank first portion proximate the airfoil portion, a shank tip distal the airfoil portion, and first and second shank sides between the first and tip distal portions thereof; and a second end for coupling a blade tip thereupon; with blade wall thickness in the airfoil portion between the outer and inner wall surfaces decreasing from the first end to the second end of the blade body, by:
laying-up ceramic fibers into a layered structure, including at least one inner layer, which delimits the inner wall surface, the inner layer having a length extending from the at least one blade shank distal tip of the first end of the blade body to the second end of the blade body,
laying-up ceramic fibers in successively shorter length extending layers over previously laid-up layers, each successively shorter layer having a length extending from the at least one blade shank distal tip of the first end toward the second end thereof, so that thickness of the composite, laid-up, successive fiber layers decreases from the first end to the second end of the blade body;
impregnating the ceramic fibers with ceramic slurry material, if those fibers were not previously impregnated with ceramic material prior to their lay-up;
curing the impregnated ceramic fibers, thereby solidifying the ceramic blade body;
forming a two-dimensional array of rows of apertures in the at least one blade shank, during or after laying-up of ceramic fibers, each of said apertures extending through the at least one blade shank between the first and second shank sides thereof, for insertion and receipt of corresponding load-carrying pins, with rows of said apertures formed proximate the distal tip thereof having larger diameter than said rows of apertures formed proximate the first portion of the at least one blade shank, so that when any axial tensile load is applied to the at least one blade shank while corresponding load-carrying pins are inserted into their respective apertures, the applied tensile load is distributed within the material forming the at least one blade shank, such that applied tensile load stress is split between successive rows of apertures from proximate the at least one blade shank distal tip to its corresponding first portion, so that each row of apertures carries its own tensile load plus aggregate tensile load of all other rows of apertures that are closer to the blade shank first portion; and
affixing a blade tip to the second end of the ceramic blade body.

17. The method of claim 16, further comprising staggering respective rows of apertures in the at least one blade shank during formation thereof, so that no third pair of apertures in any successive rows is axially aligned between the distal and first portion thereof.

18. The method of claim 16, further comprising fabricating a blade body with a pair of first and second blade shanks, the first blade shank proximate the pressure side of the blade body, and the second blade shank proximate the suction side of the blade body.

19. The method of claim 16, further comprising:
providing a pair of first and second clevis attachment pieces, respectively having an inner side with a profile conforming to that of a respective first and second shank side of the at least one blade shank, the respective inner sides of the first and second clevis attachment pieces having a two-dimensional array of rows of partial-depth apertures which correspond to those formed in the blade shank, and respectively having an outer side with a profile for mating engagement with a corresponding turbine blade-engagement recess within a turbine rotor disc;
providing a plurality of load-carrying pins, respectively having outer diameters corresponding to diameters of apertures of the two-dimensional arrays of apertures formed in the blade shank and the inner sides of the first and second clevis attachment pieces, the pins respectively having pin axial length between first and second pin ends shorter than combined axial depth of corresponding apertures formed in the blade shank and the inner sides of the first and second clevis attachment pieces;
capturing the load-carrying pins within corresponding apertures formed in the blade shank and the inner sides of the first and second clevis attachment pieces; and
installing the turbine blade in a turbine rotor disc of a combustion turbine engine, by engaging the outer sides of the first and second clevis attachment pieces, and their corresponding at least one blade shank within a turbine blade-engagement recess formed within said turbine rotor disc.

20. A method for operating a combustion turbine engine, which incorporates a row of ceramic-matrix-composite (CMC) engine blades manufactured by the method of claim 16, installed in a turbine rotor disc, comprising:
starting the engine, and applying a centrifugal, tensile load on each CMC blade within the blade row, each of said CMC blades distributing the applied tensile load within the material forming its respective at least one blade shank, such that applied tensile load stress is split between successive rows of apertures from proximate the at least one blade shank distal tip to its corresponding first portion, so that each row of apertures carries its own tensile load plus aggregate tensile load of all other rows of apertures that are closer to the blade shank first portion.
